(19) United States
(12) Patent Application Publication
(10) Pub. No.: US 2017/0100753 A1
(43) Pub. Date: Apr. 13, 2017

(54) SHEET MATERIAL SURFACE TREATMENT METHOD AND SYSTEM

(71) Applicant: USUN TECHNOLOGY CO., LTD., Taoyuan (TW)

(72) Inventor: Chiu-Fong HUANG, Taoyuan (TW)

(21) Appl. No.: 15/137,274

(22) Filed: Apr. 25, 2016

(30) Foreign Application Priority Data
Oct. 13, 2015 (TW) 104133563

(51) Int. Cl. B08B 3/02; B08B 3/04; C23C 18/16; B08B 5/04

(52) U.S. Cl. CPC B08B 3/022; B08B 5/043; B08B 3/041; C23C 18/16

(57) ABSTRACT

A sheet material surface treatment method for treating the surface of a sheet material using a surface treatment system is disclosed. The system includes a channel, a plurality of liquid processing units and gas processing units arranged in series, and a sheet-transfer mechanism for transferring sheet material from an inlet at one end of the channel toward an outlet at an opposite end of the channel so that a surface treatment liquid can be filled into each liquid processing unit to surface-treat the sheet material and gas can be drawn out of each gas processing unit to remove waste liquid and impurities from the surface of the sheet material, enabling the sheet material to be alternatively surface treated and cleaned by the liquid processing units and the gas processing units in a proper order, ensuring a high level of surface treatment quality and increasing the yield.

### BACKGROUND OF THE INVENTION

This application claims the priority benefit of Taiwan patent application number 104133563, filed on Oct. 13, 2015

1. Field of the Invention

The present invention relates to surface treatment technology and more particularly, to a sheet material surface treatment method for treating the surface of a sheet material using a sheet material surface treatment system, enabling the sheet material to be alternatively and continuously surface-treated and cleaned through a series of liquid processing units and gas processing units, ensuring a high level of surface treatment quality and increasing the yield.

2. Description of the Related Art

With continuous development of LCD screen and multi-layer glass technologies, glass substrates have been widely used in products in our daily life. After fabrication of glass substrates, they need to be abrasive-lapped on one side or both sides to flatten surface and/or to reduce the thickness. During abrasive lapping, abrasives (such as alumina or silicon carbide powdered abrasives) must be used to abrade a thickness about 5˜40 μm per minute. This abrasive-lapping procedure takes much time. Further, the stress generated during the abrasive-lapping operation can cause the glass substrate to curve. Further, the abrasive-lapping process will produce dust particles that are hazardous to human health.

Some manufacturers use an immersion type surface treatment system for surface-treating glass substrates. An immersion type surface treatment system comprises a container for holding a chemical solution, and a gripping tool for gripping each glass substrate and dipping each glass substrate in the chemical solution in the container to achieve thinning of each glass substrate subject to control of contact time between the glass substrate and the applied chemical solution. However, because the surface area of each glass substrate that was gripped by the gripping tool is etched, and a secondary processing step must be employed, prolonging the processing time.

There are some other manufacturers employ a spray-type surface treatment system for surface-treating glass substrates. A spray-type surface treatment system of this design comprises a gripping tool for gripping each glass substrate, and a plurality of jet nozzles controllable to spray a chemical solution over the surface of each glass substrate to achieve etching and thinning. When spraying the chemical solution over the surface of one glass substrate, the chemical solution spraying angle and velocity or the position of the glass substrate can be adjusted. However, because only a part of the applied chemical solution can react with the surface of the glass substrate, a large amount of the applied chemical solution flows downwards without treating the glass substrate, reducing the effects and increasing the recycling costs.

In general, the conventional surface treatment systems have drawbacks as follows:

(1) In an immersion type surface treatment system, the surface area of the glass substrate that faces toward the gripping tool cannot be well treated, resulting in an uneven surfaced treatment problem. In a spray-type surface treatment system, the jet nozzles are moved to spray the applied chemical solution over the surface of the glass substrate; this method will result in an unevenness of surface treatment and waste of a large amount of chemical solution, and the problem of unevenness of surface treatment will be more serious when treating a large size glass substrate.

(2) During operation of a spray-type surface treatment system to spray a chemical solution through multiple jet nozzles over the surface of the glass substrate, evaporation of the mist of fine droplets of the applied chemical solution will cause air pollution, and a recycling process must be employed to recycle waste chemical solution, increasing the manufacturing costs.

Further, when surface-treating a large size sheet material, it is difficult to evenly treat the surface of the sheet material, leading to increased defective rate. Therefore, it is desirable to provide a sheet material surface treatment method and system that eliminates the aforesaid various problems.

### SUMMARY OF THE INVENTION

The present invention has been accomplished under the circumstances in view. It is therefore the main object of the present invention to provide a sheet material surface treatment method and system, which enables the sheet material to be alternatively and continuously surface-treated and cleaned through a series of liquid processing units and gas processing units, achieving environmental protection, reducing pollution, saving consumables, ensuring a high level of surface treatment quality and increasing the yield.

To achieve this and other objects of the present invention, a sheet material surface treatment method uses a surface treatment system for treating the surface of a sheet material. The system includes a channel, a plurality of liquid processing units and gas processing units arranged in series, and a sheet-transfer mechanism for transferring the sheet material from an inlet at one end of the channel toward an outlet at an opposite end of the channel. Thus, a surface treatment liquid can be filled into each liquid processing unit to surface-treat the sheet material, and at the same time, gas can be drawn out of each gas processing unit to remove waste liquid and impurities from the surface of the sheet material, enabling the sheet material to be alternatively surface treated and cleaned by the liquid processing units and the gas processing units in a proper order.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a sectional side view of a surface treatment system in accordance with the present invention.

FIG. 2 is a sectional side view of an alternate form of the surface treatment system in accordance with the present invention.

FIG. 3 is a sectional side view of another alternate form of the surface treatment system in accordance with the present invention.

FIG. 4 is a flow chart of a surface treatment method in accordance with the present invention.

### DETAILED DESCRIPTION OF THE PREFERRED EMBODIMENT

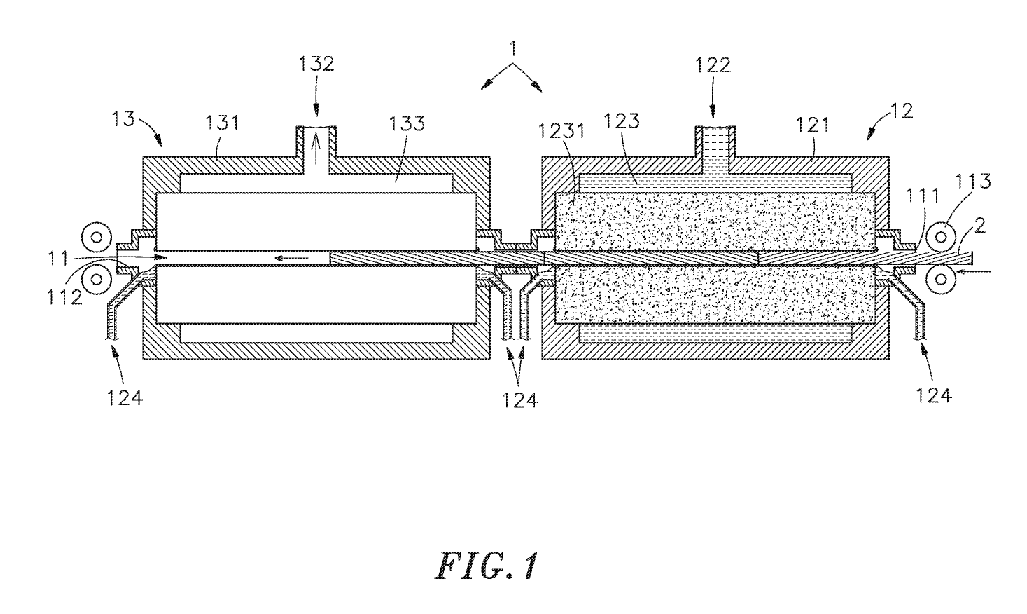

Referring to FIG. 1, a sheet material 2 is delivered through a surface treatment system 1, and surface processed therein. The surface treatment system 1 comprises an inlet 111 located at one side thereof, an outlet 112 located at an opposite side thereof, a channel 11 disposed in communication between the inlet 111 and the outlet 112, a sheet-transfer mechanism 113 for transferring the sheet material 2 from the inlet 11 through the channel 11 toward the outlet 112, and a plurality of liquid processing units 12 and gas processing units 13 alternatively arranged in series at one lateral side thereof. Each the liquid processing unit 12 comprises a liquid-processing body shell 121, a liquid chamber 123 defined in the liquid-processing body shell 121, a liquid filling hole 122 located at an outer side thereof for the filling of a liquid into the liquid chamber 123, and a plurality of liquid jet nozzles (not shown) for ejecting the liquid out of the liquid chamber 123 into the channel 11. Each the gas processing unit 13 comprises a gas-processing body shell 131, a gas chamber 133 defined in the gas-processing body shell 131, an exhaust port 132 located at an outer side thereof for the drawing of gas out of the liquid chamber 123, and a plurality of gas drawing holes disposed in communication between the gas chamber 133 and the channel 11. The surface treatment system 1 further comprises a plurality of drain holes 124 respectively extended from the inlet 111, the outlet 112, two opposite lateral sides of the liquid-processing body shell 121 of the liquid processing unit 12 and two opposite lateral sides of the gas-processing body shell 131 of the gas processing unit 13.

In application, the sheet material 2 to be processed is transferred by the sheet-transfer mechanism 113 through the inlet 111 into the channel 11 in direction toward the outlet 112. At this time, a prepared surface treatment liquid is filled into the first liquid processing unit 12 to treat the surface of the sheet material 2 in the channel 11, and then a vacuum is created in the first gas processing unit 13 to clean the surface of the sheet material 2, enabling gas and liquid to be carried away from the surface of the sheet material 2 toward the outside of the surface treatment system 1 via the exhaust port 132 of the first gas processing unit 13. As the sheet material 2 is being continuously transferred by the sheet-transfer mechanism 113 toward the outlet 112, it is alternatively treated by the other liquid processing units 12 and the gas processing units 13 in a proper order. Thus, when treating the surface of the sheet material 2, the sheet material 2 is equally divided into a series of areas that are treated by the liquid processing units 12 and the gas processing units 13 in a small surface area treatment manner in a proper order, achieving implementation of wet processing and air drying operation, ensuring a high level of surface treatment quality and increasing the yield.

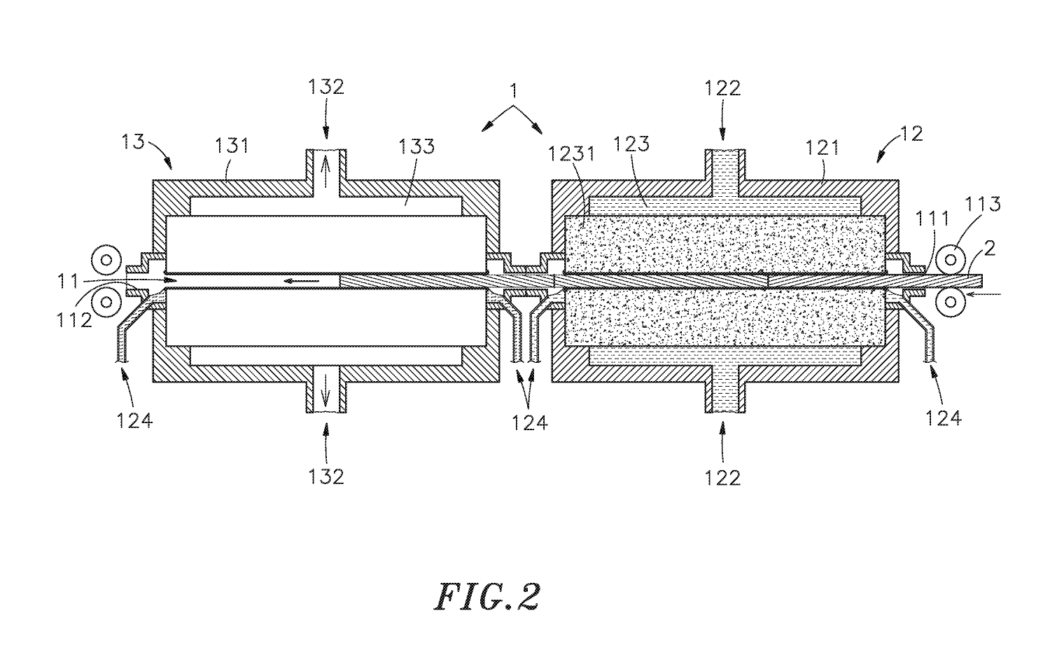

Further, as shown in FIG. 2, the drain holes 124 are respectively located at the inlet 111, the outlet 112, two opposite lateral sides of the liquid-processing body shell 121 of the liquid processing unit 12 and two opposite lateral sides of the gas-processing body shell 131 of the gas processing unit 13. When the sheet material 2 is being surface-treated or air-dried in the surface treatment system 1, waste liquid is discharged though the drain holes 124 to an external drain system, or an external waste liquid collector for recycling, achieving environmental protection, reducing pollution and saving consumables.

When a prepared surface treatment liquid is filled through the liquid filling hole 122 of one the liquid processing unit 12 into the associating liquid chamber 123, motor, ultrasonic oscillator or any other means can be used to enhance the speed of the application of the supplied surface treatment liquid over the surface of the sheet material 2. Further, the liquid chamber 123 comprises a porous shell 1231 that has a plurality of liquid jet nozzles facing toward the channel 11. Alternatively, the porous shell 1231 can be a porous ceramic.

Referring to FIG. 2 again, in an alternate form of the present invention, each the liquid processing unit 12 comprises the two liquid-processing body shells 121 symmetrically disposed at two opposite sides of the channel 11; each the gas processing unit 13 comprises the two gas-processing body shells 131 symmetrically disposed at two opposite sides of the channel 11. Thus, the embodiment shown in FIG. 1 is adapted for processing one surface of the sheet material 2; the embodiment shown in FIG. 2 is adapted for processing two opposite surfaces of the sheet material 2.

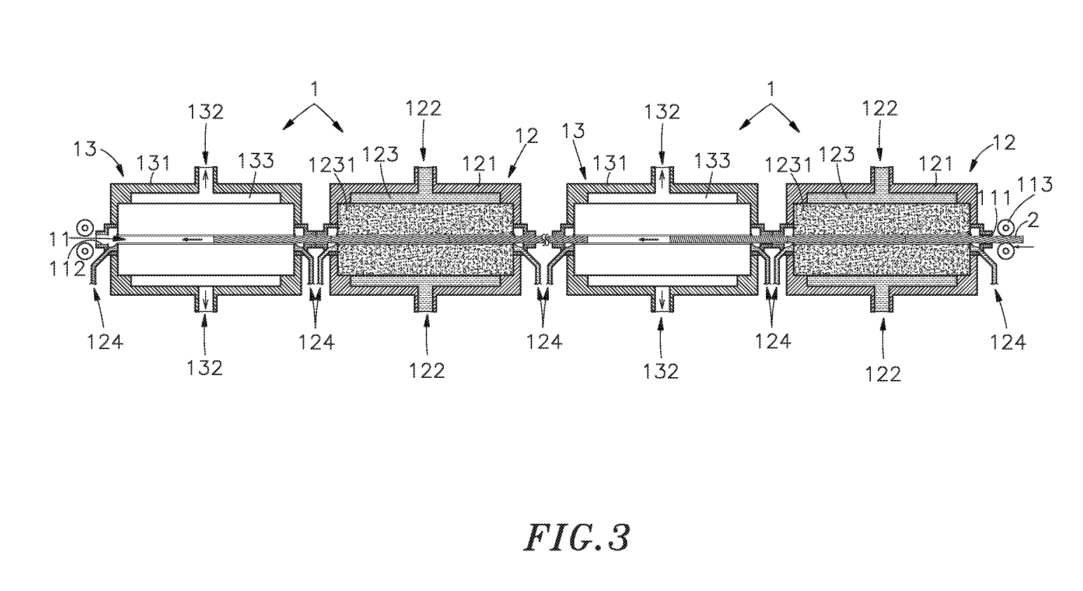

Referring to FIG. 3, the multiple liquid processing units 12 and the multiple gas processing units 13 of the surface treatment system 1 are symmetrically and alternatively arranged in two series at two opposite sides of the channel 11. Further, the surface treatment liquid can be an etchant (for example, PCB etchant solution), pure water, plating solution, or any other surface-treatment fluid. Further, the sheet material 2 can be a printed circuit board, glass substrate, metal substrate, solar panel, or any other thin-sheet material. The liquid processing units 12 are practical for the treatment works of etch-thinning, cleaning, electroplating and surface smoothing. The gas processing units 13 are practical for removing waste water, impurities and etchant from the sheet material 2, or for other cleaning works. As the sheet material 2 to be treated is being transferred from the inlet 111 of the surface treatment system 1 through the channel 11 toward the outlet 112, the sheet material 2 can be automatically surface-treated through a continuous series of processing steps, saving much the sheet material 2 delivery time and labor, ensuring a high level of surface treatment quality and increasing the yield.

Further, as stated above, the sheet-transfer mechanism 113 of the surface treatment system 1 is adapted for transferring the sheet material 2 to be treated from the inlet 111 of the surface treatment system 1 through the channel 11 toward the outlet 112. The sheet-transfer mechanism 113 is a roller-based sheet transfer mechanism. Further, a propeller or pusher can be used for pushing the sheet material 2 into the channel 11 in one direction. Alternatively, the sheet material 2 can be pushed into the channel 11 manually.

Further, the porous shell 1231 of the liquid chamber 123 of each the liquid processing unit 12 of the surface treatment system 1 can be made from ceramics, titanium, or any other anti-corrosion porous material, or material having pores arranged in arrays. As stated above, the surface treatment liquid to be applied for treating the sheet material 2 can be an etchant (for example, PCB etchant solution), pure water, plating solution, or any other surface-treatment fluid; the sheet material 2 can be a printed circuit board, glass substrate, metal substrate, solar panel, or any other thin-sheet material; the liquid processing units 12 are practical for the treatment works of etch-thinning, cleaning, electroplating and surface smoothing; the gas processing units 13 are practical for removing waste water, impurities and etchant from the sheet material 2, or for other cleaning works. Thus, the one single surface treatment system 1 is sufficient for processing the sheet material 2 automatically through a continuous series of processing steps. Thus, the surface treatment system 1 has wide applicability. Because the one single surface treatment system 1 is sufficient for processing the sheet material 2 automatically, the invention saves much plant space and equipment installation cost.

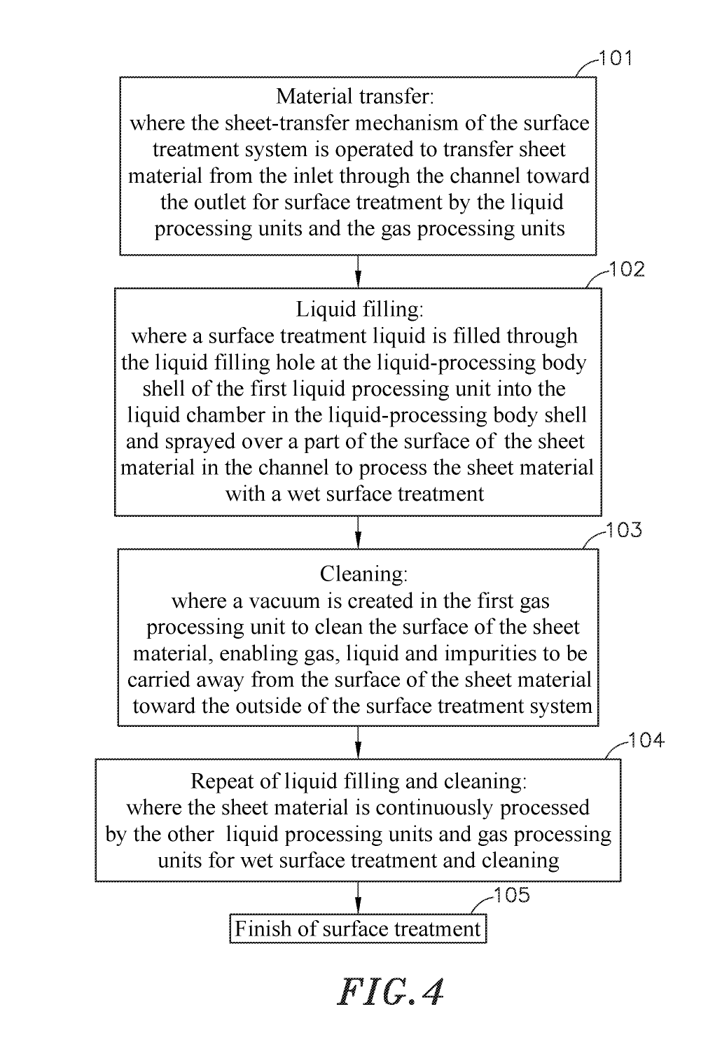

Referring to FIGS. 3 and 4, the sheet material surface treatment method of the present invention includes the steps of:

(101) Material transfer: where the sheet-transfer mechanism 113 of the surface treatment system 1 is operated to transfer the sheet material 2 from the inlet 111 through the channel 11 toward the outlet 112 for surface treatment by the liquid processing units 12 and the gas processing units 13.

(102) Liquid filling: where a surface treatment liquid is filled through the liquid filling hole 122 at the liquid-processing body shell 121 of the first liquid processing unit 12 into the associating liquid chamber 123 and sprayed over a part of the surface of the sheet material 2 in the channel 11 to process the sheet material 2 with a wet surface treatment.

(103) Cleaning: where a vacuum is created in the first gas processing unit 13 to clean the surface of the sheet material 2, enabling gas, liquid and impurities to be carried away from the surface of the sheet material 2 toward the outside of the surface treatment system 1 via the exhaust port 132 of the first gas processing unit 13.

(104) Repeat of liquid filling and cleaning: where the sheet material 2 is continuously processed by the other liquid processing units 12 and the gas processing units 13 for wet surface treatment and cleaning.

(105) Finish of surface treatment.

During the aforesaid step (102) of liquid filling, the applied surface treatment liquid is forced out of the liquid chamber 123 through pores in the porous shell 1231 and evenly applied to the surface of the sheet material 2, enabling the surface of the sheet material 2 to be uniformly surface-treated. The porous shell 1231 can be a sintered ceramic shell having tiny pores therein through which the applied surface treatment liquid leaks out of the porous shell 1231 in a low flow rate manner to form a thin layer of surface treatment liquid on the surface of the sheet material 2 in the channel 11. Further, if the embodiment of the surface treatment system 1 shown in FIG. 2 is used, the two opposite surfaces of the sheet material 2 can be surface treated at the same time.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A sheet material surface treatment method for treating the surface of a sheet material using a surface treatment system, said surface treatment system comprising an inlet, an outlet, a channel disposed in communication between said inlet and said outlet, a sheet-transfer mechanism for transferring said sheet material from said inlet through said channel toward said outlet and a plurality of liquid processing units and gas processing units alternatively arranged in series, said sheet material surface treatment method comprising the steps of:
(i) material transfer, where said sheet-transfer mechanism of said surface treatment system is operated to transfer said sheet material from said inlet through said channel toward said outlet for surface treatment by said liquid processing units and said gas processing units;
(ii) liquid filling, where a surface treatment liquid is filled through a liquid filling hole at a liquid-processing body shell of a first one of said liquid processing units into a liquid chamber in said liquid-processing body shell of said first liquid processing unit and sprayed over a part of the surface of said sheet material in said channel to process said sheet material with a wet surface treatment;
(iii) cleaning, where a vacuum is created in said first gas processing unit to clean the surface of said sheet material, enabling gas, liquid and impurities to be carried away from the surface of said sheet material toward the outside of said surface treatment system;
(iv) repeat of liquid filling and cleaning, where said sheet material is continuously processed by the other said liquid processing units and the other said gas processing units for wet surface treatment and cleaning; and
(v) finish of surface treatment.

2. The sheet material surface treatment method as claimed in claim 1, wherein said liquid chamber of said surface treatment system comprises a porous shell having arrays of pores therein for absorbing said surface treatment liquid and applying said surface treatment liquid onto the surface of said sheet material.

3. The sheet material surface treatment method as claimed in claim 2, wherein said porous shell is selectively made from ceramics or titanium.

4. The sheet material surface treatment method as claimed in claim 1, wherein said surface treatment system further comprises a plurality of drain holes respectively extended from said inlet, said outlet, two opposite lateral sides of the liquid-processing body shell of each said liquid processing unit and two opposite lateral sides of a gas-processing body shell of each said gas processing unit.

5. A surface treatment system for surface-treating a sheet material, comprising an inlet, an outlet, a channel disposed in communication between said inlet and said outlet and a plurality of liquid processing units and gas processing units alternatively arranged in series, each said liquid processing unit comprising at least one liquid-processing body shell, a liquid chamber defined in each said liquid-processing body shell, a liquid filling hole located at an outer side for the filling of a liquid into said liquid chamber, and a plurality of liquid jet nozzles for ejecting the applied liquid out of said liquid chamber into said channel, each said gas processing unit comprising at least one gas-processing body shell, a gas chamber defined in each said gas-processing body shell, an exhaust port located at an outer side for the drawing of gas out of said liquid chamber and a plurality of gas drawing holes disposed in communication between said gas chamber and said channel.

6. The surface treatment system as claimed in claim 5, further comprising a sheet-transfer mechanism for transferring said sheet material from said inlet through said channel toward said outlet.

7. The surface treatment system as claimed in claim 6, wherein said sheet-transfer mechanism is a roller-based sheet transfer mechanism.

8. The surface treatment system as claimed in claim 5, wherein said liquid chamber of said surface treatment system comprises a porous shell having arrays of pores therein for absorbing said surface treatment liquid and applying said surface treatment liquid onto the surface of said sheet material.

9. The surface treatment system as claimed in claim 8, wherein said porous shell is selectively made from ceramics or titanium.

10. The surface treatment system as claimed in claim 5, further comprises a plurality of drain holes respectively extended from said inlet, said outlet, two opposite lateral sides of the liquid-processing body shell of each said liquid processing unit and two opposite lateral sides of said gas-processing body shell of each said gas processing unit.
